(19) United States
(12) Patent Application Publication
(10) Pub. No.: US 2010/0323197 A1
(43) Pub. Date: Dec. 23, 2010

(54) ACRYLIC VISCOELASTIC COMPOSITION AND PRESSURE-SENSITIVE ADHESIVE TAPE OR SHEET

(75) Inventors: Kazuhisa Maeda, Ibaraki-shi (JP); Yusuke Sugino, Ibaraki-shi (JP)

Correspondence Address: SUGHRUE-265550, 2100 PENNSYLVANIA AVE. NW, WASHINGTON, DC, 20037-3213, US

(73) Assignee: NITTO DENKO CORPORATION, Ibaraki-shi (JP)

(21) Appl. No.: 12/667,476

(22) PCT Filed: Jul. 3, 2008
(86) PCT No.: PCT/JP2008/062056

§ 371 Date: Dec. 31, 2009

(30) Foreign Application Priority Data
Jul. 4, 2007 (JP) 2007-175957

(51) Int. Cl. B32B 27/30; C08L 33/10

(52) U.S. Cl. 428/355 AC; 525/55; 525/301

(57) ABSTRACT

The present invention relates to an acrylic viscoelastic composition including an acrylic polymer A obtained by polymerizing an acrylic monomer mixture containing an alkyl (meth)acrylate (a) and a terpene-based (meth)acrylate (b), the terpene-based (meth)acrylate (b) being contained in an amount of 5 to 70% by weight based on the total monomer components of the acrylic monomer mixture; and a tackifying component B having a weight average molecular weight of 2,000 to 20,000.

### TECHNICAL FIELD

The present invention relates to an acrylic viscoelastic composition and a pressure-sensitive adhesive tape or sheet having a pressure-sensitive adhesive layer including the acrylic viscoelastic composition.

### BACKGROUND ART

As viscoelastic products including acrylic polymers, for example, pressure-sensitive adhesive-processed products such as acrylic pressure-sensitive adhesives, acrylic pressure-sensitive adhesive tapes or sheets, double-coated pressure-sensitive adhesive tapes or sheets, and foams are well known.

Moreover, since an acrylic pressure-sensitive adhesive contains an acrylic polymer as a main component, the acrylic pressure-sensitive adhesive is excellent in light resistance, weather resistance, oil resistance and the like. Also, an acrylic pressure-sensitive adhesive tape or sheet using a plastic film, paper or the like as a surface substrate is excellent in pressure-sensitive adhesive properties such as pressure-sensitive adhesive force and cohesive force, and antiaging properties such as heat resistance and weather resistance, and has been widely used.

As a method for producing the acrylic pressure-sensitive adhesive, a method of using an organic solvent, a method of preparation by emulsion polymerization, and a method of preparation by bulk polymerization (ultraviolet ray polymerization) with ultraviolet ray irradiation in the presence of an ultraviolet ray polymerization initiator without using any organic solvent or water are known. In recent years, from the viewpoint of environmental pollution, a method of preparation without using any organic solvent is preferable in many cases and also a method of an ultraviolet ray polymerization without using any substance which deteriorates properties, such as an emulsifier, is preferably used.

The adhesive performance of the acrylic pressure-sensitive adhesive to non-polar adherends, such as polyolefins represented by polypropylene (PP), is not high. Also, the adhesive performance to coated plates, particularly in recent years, coated plates which become poorly-adherent by the influence of popularization of acid rain-resistant or water-borne ones (poorly-adherent coated plates) is not high.

As a method for increasing adhesive performance of the acrylic pressure-sensitive adhesive to polyolefins, a method of using a tackifying resin (tackifier) is known. Patent Documents 1 and 2 disclose methods of adding a specific tackifying resin such as rosin or a hydrogenated petroleum-based one to an acrylic polymer. However, a sufficient adhesive performance to polyolefins cannot be obtained even when these methods are used. Moreover, since these tackifying resins absorb ultraviolet ray, it cannot be used in the method of obtaining an acrylic polymer by ultraviolet ray polymerization (photopolymerization). Patent Document 3 discloses a method of adding a (meth)acrylic oligomer having a weight average molecular weight of 20,000 or less to an acrylic polymer. However, in this method, the (meth)acrylic oligomer having a weight average molecular weight of 20,000 or less capable of improving the adhesive performance to polyolefins exhibits a poor compatibility with the acrylic polymer to be used as a pressure-sensitive adhesive and there arises a problem that adhesive performance decreases when the tape is stored for a long term or at high temperature. Patent Document 4 discloses an acrylic pressure-sensitive adhesive tape using a (meth)acrylic oligomer having a weight average molecular weight of 20,000 or less and having a glass transition temperature (Tg) of 25° C. or higher. However, the (meth)acrylic oligomer having a weight average molecular weight of 20,000 or less and having a glass transition temperature (Tg) of 25° C. or higher exhibits a poor compatibility with the polymer and there arises a problem that adhesive performance decreases when the tape is stored for a long term or at high temperature.

### Patent Document 1: JP-A-6-207151

### Patent Document 2: JP-T-11-504054

### Patent Document 3: JP-A-2001-49200

### Patent Document 4: JP-A-2003-49130

### DISCLOSURE OF THE INVENTION

Accordingly, an object of the present invention is to provide an acrylic viscoelastic composition which can exhibit an excellent adhesive performance to a poorly-adherent adherend, particularly a polyolefin adherend or a poorly-adherent coated plate and can prevent a decrease in adhesive performance by long-term storage or high-temperature storage.

Another object of the invention is to provide a pressure-sensitive adhesive tape or sheet which can exhibit an excellent adhesive performance to a poorly-adherent adherend, particularly a polyolefin adherend or a poorly-adherent coated plate and can prevent a decrease in adhesive performance by long-term storage or high-temperature storage.

As a result of the extensive studies for solving the above problems, the present inventors have found that, in the acrylic viscoelastic composition including an acrylic polymer and a tackifying component, an excellent adhesive performance to a poorly-adherent adherend, particularly a polyolefin adherend or a poorly-adherent coated plate can be exhibited and a decrease in adhesive performance by long-term storage or high-temperature storage can be prevented when an acrylic polymer obtained by copolymerizing an alkyl (meth)acrylate and a terpene-based (meth)acrylate is used as an acrylic polymer. Thus, they have accomplished the invention.

Namely, the invention relates to the following (1) to (9).

(1) An acrylic viscoelastic composition including:

an acrylic polymer A obtained by polymerizing an acrylic monomer mixture containing an alkyl (meth)acrylate (a) and a terpene-based (meth)acrylate (b), the terpene-based (meth)acrylate (b) being contained in an amount of 5 to 70% by weight based on the total monomer components of the acrylic monomer mixture; and

a tackifying component B having a weight average molecular weight of 2,000 to 20,000.

(2) The acrylic viscoelastic composition according to (1), in which the tackifying component B is contained in an amount of 1 to 50 parts by weight based on 100 parts by weight of the acrylic polymer A.

(3) The acrylic viscoelastic composition according to (1) or (2), in which the acrylic polymer A further contains, as a monomer component, a polar group-containing monomer (c) copolymerizable with the alkyl (meth)acrylate (a), in an amount of 0.1 to 20% by weight based on the total monomer components of the acrylic monomer mixture.

(4) The acrylic viscoelastic composition according to any one of (1) to (3), in which the acrylic monomer mixture further contains a photopolymerization initiator in an amount of 0.001 to 5 parts by weight based on 100 parts by weight of the total monomer components of the acrylic monomer mixture.

(5) The acrylic viscoelastic composition according to any one of (1) to (4), in which the tackifying component B is a (meth)acrylic oligomer.

(6) The acrylic viscoelastic composition according to (5), in which the (meth)acrylic oligomer has a glass transition temperature (Tg) of 20° C. or higher.

(7) The acrylic viscoelastic composition according to any one of (1) to (6), in which the tackifying component B contains a chain transfer agent in an amount of 0.005 to 20 parts by weight based on 100 parts by weight of the total monomer components constituting the tackifying component B.

(8) A pressure-sensitive adhesive tape or sheet having a pressure-sensitive adhesive layer including the acrylic viscoelastic composition according to any one of (1) to (7).

(9) A pressure-sensitive adhesive tape or sheet including a substrate; and a pressure-sensitive adhesive layer including the acrylic viscoelastic composition according to any one of (1) to (7) provided on at least one surface of the substrate.

According to the acrylic viscoelastic composition of the invention, owing to the above-mentioned constitution, it is possible to exhibit an excellent adhesive performance to a poorly-adherent adherend, particularly a polyolefin adherend or a poorly-adherent coated plate and can prevent a decrease in adhesive performance by long-term storage or high-temperature storage.

Moreover, the pressure-sensitive adhesive tape or sheet of the invention can exhibit an excellent adhesive performance to a poorly-adherent adherend, particularly a polyolefin adherend or a poorly-adherent coated plate and can prevent a decrease in adhesive performance by long-term storage or high-temperature storage.

### BEST MODE FOR CARRYING OUT THE INVENTION

### Acrylic Viscoelastic Composition

The acrylic viscoelastic composition of the invention includes an acrylic polymer A obtained by polymerizing an acrylic monomer mixture containing an alkyl (meth)acrylate (a) and a terpene-based (meth)acrylate (b), the terpene-based (meth)acrylate (b) being contained in an amount of 5 to 70% by weight based on the total monomer components; and a tackifying component B having a weight average molecular weight of 2,000 to 20,000.

In this connection, the acrylic viscoelastic composition may contain polymers other than the acrylic polymer A (e.g., rubber-based polymers, vinyl alkyl ether-based polymers, silicone-based polymers, polyester-based polymers, polyamide based-polymers, urethane-based polymers, fluorine-based polymers, and epoxy-based polymers) within a range where the effect of the present invention is not impaired.

### Acrylic Polymer A

The acrylic polymer A is a main component of the acrylic viscoelastic composition and can be obtained by polymerizing an acrylic monomer mixture containing an alkyl (meth)acrylate (a) and a terpene-based (meth)acrylate (b), the terpene-based (meth)acrylate (b) being contained in an amount of 5 to 70% by weight based on the total monomer components.

Since the acrylic polymer A is used as a main component of the acrylic viscoelastic composition, it is important that the ratio thereof is 60% by weight or more, and preferably 70% by weight or more based on the total amount of the acrylic viscoelastic composition.

Examples of the alkyl (meth)acrylate (a) constituting the acrylic monomer mixture include (meth)acrylic acid alkyl esters having an alkyl group containing 1 to 20 carbon atoms [preferably (meth)acrylic acid alkyl esters having an alkyl group containing 1 to 14 carbon atoms and more preferably (meth)acrylic acid alkyl esters having an alkyl group containing 2 to 10 carbon atoms] such as methyl (meth)acrylate, ethyl (meth)acrylate, propyl (meth)acrylate, isopropyl (meth)acrylate, butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, and eicosyl (meth)acrylate. These (meth)acrylic acid alkyl esters can be used alone or in combination of two or more thereof.

The terpene-based (meth)acrylate (b) can be obtained by esterifying a terpene alcohol-based compound with a (meth)acrylic acid-based compound. The esterification reaction can be suitably selected from known methods. The terpene-based (meth)acrylate (b) can be obtained by subjecting the terpene alcohol-based compound and the (meth)acrylic acid-based compound to a transesterification reaction in the presence of a esterification catalyst and removing a generated alcohol.

The terpene-based (meth)acrylate (b) improves compatibility of the acrylic polymer A formed by copolymerization the terpene-based (meth)acrylate (b) with the alkyl (meth)acrylate (a), with the tackifying component B [particularly, a (meth)acrylic oligomer] in the acrylic viscoelastic composition, whereby, a decrease in adhesiveness with time can be prevented in the acrylic viscoelastic composition including the acrylic polymer A and the tackifying component B.

The terpene-based (meth)acrylate (b) preferably has a glass transition temperature (Tg) of 0° C. or lower in a homopolymer of the terpene-based (meth)acrylate (b), from the viewpoint of adhesiveness. In this connection, the glass transition temperature (Tg) of the homopolymer of the terpene-based (meth)acrylate (b) can be determined by DSC (differential scanning calorimetry).

The terpene alcohol-based compound can be obtained: by hydrogenating or reducing a compound obtained by subjecting a terpene compound and a (meth)acrylic acid-based compound to the Diels-Alder reaction; or by formaldehyde addition reaction or water addition reaction of terpene-based compound.

The terpene-based compound is a generic term of compounds obtained by extraction from essential oil components of plants and represented by the molecular formula C₅H₈ on the basis of the isoprene rule. Examples thereof include limonene, dipentene, α-pinene, β-pinene, ocimene, myrcene, α-terpinen, β-terpinen, 3,8-p-menthadiene, carene, camphene, terpinolene, allo-ocimene, α-cedrene, β-cedrene, α-caryophyllene, α-farnesene, β-farnesene, α-phellandrene and β-phellandrene. These terpene-based compounds may be used alone or in combination of two or more thereof.

The (meth)acrylic acid-based compound is not particularly limited and examples thereof include (meth)acrylic acid, acrolein and the above-mentioned alkyl (meth)acrylate (a) [above-mentioned (meth)acrylic acid alkyl ester]. The (meth)acrylic acid-based compounds may be used alone or in combination of two or more thereof.

Specific examples of the terpene-based (meth)acrylate (b) include 3-(4-methyl-cyclohexan-1-yl)-butyl acrylate (MCBA) and 2-{1-methyl-1-(4-methylcyclohexyl)ethoxy}-2-ethyl acrylate.

As the content of the terpene-based (meth)acrylate (b) in the acrylic monomer mixture is 5 to 70% by weight (preferably 10 to 60% by weight, and more preferably 20 to 50% by weight) based on the total monomer components of the acrylic monomer mixture. When the content is less than 5% by weight, the above-mentioned effects (improvement in adhesiveness of the acrylic viscoelastic composition to poorly-adherent adherends and suppression of a decrease in adhesiveness by long-term storage or high-temperature storage) cannot be obtained in some cases. On the other hand, when the content thereof is more than 70%, the pressure-sensitive adhesive properties decrease in some cases.

In the acrylic polymer A, various copolymerizable monomers such as a polar group-containing monomer (c) and a polyfunctional monomer may be used as monomer components. By using such copolymerizable monomers as monomer components, for example, it is possible to improve the adhesive force or enhance the cohesive force. The copolymerizable monomers can be used alone or in combination of two or more thereof.

Examples of the above-mentioned polar group-containing monomer (c) include carboxyl group-containing monomers such as (meth)acrylic acid, itaconic acid, maleic acid, fumaric acid, crotonic acid and isocrotonic acid or anhydrides thereof (maleic anhydride, etc.); hydroxyl group-containing monomers such as hydroxyethyl (meth)acrylate, hydroxypropyl (meth)acrylate and hydroxybutyl (meth)acrylate; amide group-containing monomers such as acrylamide, methacrylamide, N,N-dimethyl(meth)acrylamide, N-methylol(meth)acrylamide, N-methoxymethyl(meth)acrylamide and N-butoxymethyl(meth)acrylamide; amino group-containing monomers such as aminoethyl (meth)acrylate, dimethylaminoethyl (meth)acrylate and t-butylaminoethyl (meth)acrylate; glycidyl group-containing monomers such as glycidyl (meth)acrylate and methylglycidyl (meth)acrylate; cyano group-containing monomers such as acrylonitrile and methacrylonitrile; and heterocycle-containing vinyl monomers such as N-vinyl-2-pyrrolidone, (meth) acryloylmorpholine, N-vinylpyridine, N-vinylpiperidone, N-vinylpyrimidine, N-vinylpiperazine, N-vinylpyrazine, N-vinylpyrrole, N-vinylimidazole and N-vinyloxazole. As the polar group-containing monomer (c), a carboxyl group-containing monomer such as acrylic acid or an anhydride thereof is preferred.

The polar group-containing monomer (c) is, for example, used in an amount of 0.1 to 20% by weight (preferably, 0.3 to 15% by weight, and more preferably 0.5 to 10% by weight) based on the total monomer components of the acrylic monomer mixture constituting the acrylic polymer A. When the amount of the polar group-containing monomer (c) exceeds 20% by weight based on the total monomer components of the acrylic monomer mixture constituting the acrylic polymer A, there is a possibility that, for example, the cohesive force of the acrylic polymer A is excessively elevated and thus the pressure-sensitive adhesiveness of the acrylic viscoelastic composition is lowered. When the amount of the polar group-containing monomer (c) is excessively small (e.g., less than 0.1% by weight based on the total monomer components of the acrylic monomer mixture constituting the acrylic polymer A), there is a possibility that, for example, the cohesive force of the acrylic polymer A is lowered and thus a high shear force cannot be obtained.

When the polyfunctional monomer is used according to needs, the cohesive force of the acrylic polymer A can be controlled. Examples of such a polyfunctional monomer include hexanediol di(meth)acrylate, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl (meth)acrylate, vinyl (meth)acrylate, divinylbenzene, epoxy acrylate, polyester acrylate, urethane acrylate, butyl di(meth)acrylate and hexyl di(meth)acrylate.

The polyfunctional monomer is used in an amount of 2% by weight or less (e.g., 0.01 to 2% by weight), preferably 0.02 to 1% by weight, based on the total monomer components of the acrylic monomer mixture constituting the acrylic polymer A. When the amount of the polyfunctional monomer exceeds 2% by weight based on the total monomer components of the acrylic monomer mixture constituting the acrylic polymer A, there is a possibility that, for example, the cohesive force of the acrylic polymer A is excessively elevated and thus the pressure-sensitive adhesiveness is lowered. When the amount of the polyfunctional monomer is excessively small (e.g., less than 0.01% by weight based on the total monomer components of the acrylic monomer mixture constituting the acrylic polymer A), for example, the cohesive force of the acrylic polymer A is lowered.

Examples of the copolymerizable monomers other than the polar group-containing monomers and polyfunctional monomers include vinyl esters such as vinyl acetate and vinyl propionate; aromatic vinyl compounds such as styrene and vinyl toluene; olefins or dienes such as ethylene, butadiene, isoprene and isobutylene; vinyl ethers such as vinyl alkyl ethers; vinyl chloride; alkoxyalkyl (meth)acrylate-based monomers such as methoxyethyl (meth)acrylate and ethoxyethyl (meth)acrylate; sulfonic acid group-containing monomers such as sodium vinylsulfonate; phosphoric acid group-containing monomers such as 2-hydroxyethyl acryloyl phosphate; imide group-containing monomers such as cyclohexylmaleimide and isopropylmaleimide; isocyanate group-containing monomers such as 2-methacryloyloxyethyl isocyanate; fluorine atom-containing (meth)acrylates; and silicon atom-containing (meth)acrylates.

The acrylic polymer A preferably has a glass transition temperature (Tg) of 0° C. or lower (preferably −10° C. or lower) from the viewpoint of pressure-sensitive adhesiveness. The glass transition temperature (Tg) of the acrylic polymer A can be controlled, for example, by suitably selecting the kind of the monomer components constituting the acrylic polymer and the content thereof. The glass transition temperature (Tg) of the acrylic polymer A can be determined by DSC (differential scanning calorimeter).

In the present invention, at the preparation of the acrylic polymer A, a curing reaction with heat or an active energy beam using a polymerization initiator such as a thermal polymerization initiator or a photopolymerization initiator (photoinitiator) can be utilized.

The above-mentioned photopolymerization initiator is not particularly limited. For example, a benzoin ether-based photopolymerization initiator, an acetophenone-based photopolymerization initiator, an α-ketol-based photopolymerization initiator, an aromatic sulfonyl chloride-based photopolymerization initiator, a photo active oxime-based photopolymerization initiator, a benzoin-based photopolymerization initiator, a benzyl-based photopolymerization initiator, a benzophenone-based photopolymerization initiator, a ketal-based photopolymerization initiator, a thioxanthone-based photopolymerization initiator, an acylphosphine-based photopolymerization initiator, or the like can be used.

Specifically, examples of the benzoin ether-based photopolymerization initiator include benzoin methyl ether, benzoin ethyl ether, benzoin propyl ether, benzoin isopropyl ether, benzoin isobutyl ether, 2,2-dimethoxy-1,2-diphenylethan-1-one and anisole methyl ether. Examples of the acetophenone-based photopolymerization initiator include 2,2-diethoxyacetophenone, 2,2-dimethoxy-2-phenylacetophenone, 1-hydroxycyclohexyl phenyl ketone, 4-phenoxydichloroacetophenone and 4-t-butyl-dichloroacetophenone. Examples of the α-ketol-based photopolymerization initiator include 2-methyl-2-hydroxypropiophenone and 1-[4-(2-hydroxyethyl)-phenyl]-2-hydroxy-2-methylpropan-1-one. Examples of the aromatic sulfonyl chloride-based photopolymerization initiator include 2-naphthalenesulfonyl chloride. Examples of the photo active oxime-based photopolymerization initiator include 1-phenyl-1,1-propanedion-2-(o-ethoxycarbonyl)-oxime.

Examples of the benzoin-based photopolymerization initiator include benzoin. Examples of the benzyl-based photopolymerization initiator include benzil. Examples of the benzophenone-based photopolymerization initiator include benzophenone, benzoylbenzoic acid, 3,3′-dimethyl-4-methoxybenzophenone, polyvinyl benzophenone and α-hydroxycyclohexyl phenyl ketone. Examples of the ketal-based photopolymerization initiator include benzyl dimethyl ketal. Examples of the thioxanthone-based photopolymerization initiator include thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, 2,4-diisopropylthioxanthone and dodecylthioxanthone. Examples of the acylphosphine-based photopolymerization initiator include bis(2,4,6-trimethylbenzoyl)phenylphosphine oxide, bis(2,4,6-trimethylbenzoyl)-2,4-di-n-butoxyphenylphosphine oxide, 2,4,6-trimethylbenzoyldiphenylphosphine oxide and bis(2,6-dimethoxybenzoyl)-2,4,4-trimethylbentylphosphine oxide.

The amount of the photopolymerization initiator is not particularly limited but, for example, it can be used in an amount selected from the range of 0.001 to 5 parts by weight (preferably 0.005 to 3 parts by weight) based on 100 parts by weight of the total monomer components of the acrylic monomer mixture. These photopolymerization initiators can be used alone or in combination of two or more thereof.

In activating the photopolymerization initiator, it is important to irradiate the acrylic monomer mixture with an active energy beam. Examples of such an active energy beam include ionizing radiations such as α-ray, β-ray, γ-ray, neutron ray and electron beam and also ultraviolet ray. Of these, ultraviolet ray is preferable. The irradiation energy, irradiation time, irradiation method, etc. of the active energy beam are not particularly limited so long as the photopolymerization initiator can be activated to induce the reaction of the monomer components.

Examples of the above-mentioned thermal polymerization initiator include azo-based polymerization initiators [e.g., 2,2′-azobisisobutyronitrile, 2,2′-azobis-2-methylbutyronitrile, dimethyl 2,2′-azobis(2-methylpropionate), 4,4′-azobis-4-cyanovaleric acid, azobisisovaleronitrile, 2,2′-azobis(2-amidinopropane) dihydrochloride, 2,2′-azobis[2-(5-methyl-2-imidazolin-2-yl)propane] dihydrochloride, 2,2′-azobis(2-methylpropionamidine) disulfate, 2,2′-azobis(N,N′-dimethyleneisobutylamidine) dihydrochloride, etc.]; peroxide-based polymerization initiators (e.g., dibenzoyl peroxide and tert-butyl permaleate, etc.); and redox polymerization initiators. The amount of the thermal polymerization initiator is not particularly limited and may be within a range conventionally usable as a thermal polymerization initiator.

The acrylic monomer mixture constituting the acrylic polymer A may contain various additives such as a thickener, a thixotropic agent, a bulking agent, a filler, a plasticizer, an aging inhibitor, an antioxidant and a colorant within a range which does not inhibit polymerizing ability according to needs for applications of the acrylic viscoelastic composition. Examples of the thickener include acrylic rubber, epichlorohydrin rubber and butyl rubber. Examples of the thixotropic agent include colloidal silica and polyvinylpyrrolidone. Examples of the bulking agent include calcium carbonate, titanium oxide and clay. Examples of the filler include inorganic hollow materials such as glass balloon, alumina balloon and ceramic balloon; organic hollow materials such as vinylidene chloride balloon and acryl balloon; organic spherical materials such as nylon beads, acryl beads and silicone beads; single filaments of polyester, rayon, nylon, etc.; and micro powders of polyethylene, polypropylene, etc. Examples of the colorant include pigments and dyes. The acrylic viscoelastic composition may contain cells.

### Tackifying Component B

The tackifying component B (tackifier B) is a component to be used from the viewpoint of improving pressure-sensitive adhesiveness of the acrylic viscoelastic composition and constitutes the acrylic viscoelastic composition together with the above-mentioned acrylic polymer A. The tackifying component B can be used alone or in combination of two or more thereof. Moreover, the tackifying component B may be added after the formation of the acrylic polymer A or may be added to the acrylic monomer mixture which forms the acrylic polymer A.

The tackifying component B has a weight average molecular weight (Mw) of 2,000 to 20,000 (preferably 2,000 to 10,000, more preferably 2,000 to 6,000). When the weight average molecular weight exceeds 20,000, there is a case where the improving effect of the pressure-sensitive adhesive performance is not sufficiently obtained. When it is less than 2,000, the acrylic polymer A has exceedingly low molecular weight, so that there is a possibility that deterioration of the pressure-sensitive adhesive performance and holding performance may be caused. The weight average molecular weight is defined by the measuring method described in Examples of the present application.

The tackifying component B is not particularly limited so long as it is an organic compound capable of improving the pressure-sensitive adhesiveness of the acrylic viscoelastic composition and further having a weight average molecular weight within the above-mentioned range. Examples thereof include rosin-based tackifying resins, terpene-based tackifying resins, phenol-based tackifying resins, hydrocarbon-based tackifying resins, ketone-based tackifying resins, polyamide-based tackifying resins, epoxy-based tackifying resins, elastomer-based tackifying resins, xylene resins and (meth)acrylic oligomers.

The tackifying component B can be used without particular limitation but, for example, in the case where it is added to the acrylic monomer mixture which forms the acrylic polymer A by photopolymerization in the preparation of the acrylic viscoelastic composition, a water adduct of any of the above-mentioned various resins or a (meth)acrylic oligomer is preferable, and particularly, a (meth)acrylic oligomer is preferable from the viewpoint of suppressing photopolymerization inhibition.

Moreover, as the tackifying component B, the (meth)acrylic oligomer is preferable from the viewpoint of improving adhesiveness to poorly-adherent adherends and preventing a decrease in adhesive performance by long-term storage and high-temperature storage. This is because the (meth)acrylic oligomer has particularly excellent compatibility with the acrylic copolymer (acrylic polymer A) obtained by copolymerization of the terpene-based (meth)acrylate (b) and the alkyl (meth)acrylate (a).

Examples of the rosin-based tackifying resins include unmodified rosins (raw rosins) such as gum rosin, wood rosin and toll oil rosin, and modified rosins where these unmodified rosins are modified by, for example, hydrogenation, disproportionation or polymerization (hydrogenated rosins, disproportionated rosins, polymerized rosins, other chemically modified rosins, etc.) and also various rosin derivatives. Examples of the above-mentioned rosin derivatives include rosin esters such as rosin ester compounds obtained by esterifying unmodified rosins with alcohols and modified rosin ester compounds obtained by esterifying modified rosins such as hydrogenated rosins, disproportionated rosins and polymerized rosins with alcohols; unsaturated aliphatic acid-modified rosins obtained by modifying unmodified rosins and modified rosins (hydrogenated rosins, disproportionated rosins, polymerized rosins, etc.) with unsaturated aliphatic acids; unsaturated aliphatic acid-modified rosin esters obtained by modifying rosin esters with unsaturated aliphatic acids; rosin alcohols obtained by reduction treatment of the carboxyl group in unmodified rosins, modified rosins (hydrogenated rosins, disproportionated rosins, polymerized rosins, etc.), unsaturated aliphatic acid-modified rosins and unsaturated aliphatic acid-modified rosin esters; and metal salts of unsaturated rosins, modified rosins and rosins such as various rosin derivatives (particularly, rosin esters).

Examples of the terpene-based tackifying resins include terpene-based resins such as α-pinene polymer, β-pinene polymer and dipentene polymer; and modified terpene-based resins (e.g., terpene-phenol-based resins, styrene-modified terpene-based resins, aromatic modified terpene-based resins, hydrogenated terpene-based resins, etc.) obtained by modification of these terpene-based resins (phenol modification, aromatic modification, hydrogenation modification, hydrocarbon modification, etc.).

As the phenol-based tackifying resins, there may be mentioned condensates of various phenols with formaldehyde. Examples of the phenols include phenol, m-cresol, 3,5-xylenol, p-alkylphenol and resorcin. Specifically, examples of the phenol-based tackifying resins include alkylphenol-based resins and xylene-formaldehyde-based resins. Moreover, as the phenol-based tackifying resin, there may be used resols obtained by addition reaction of the above-mentioned phenols and formaldehyde with an alkali catalyst, novolaks obtained by condensation reaction of the above-mentioned phenols and formaldehyde with an acid catalyst, and also rosin phenol resins obtained by addition of phenol to rosins (unmodified rosins, modified rosins, various rosin derivatives, etc.) with an acid catalyst and thermal polymerization.

Examples of the hydrocarbon-based tackifying resins include aliphatic hydrocarbon resins [polymers of aliphatic hydrocarbons such as olefins and dienes having 4 to 5 carbon atoms (olefins such as butene-1, isobutylene and pentene-1; dienes such as butadiene, 1,3-pentadiene and isoprene), etc.], aliphatic cyclic hydrocarbon resins [alicyclic hydrocarbon-based resins obtained by cyclic dimerization of so-called “C4 petroleum fraction” or “C5 petroleum fraction” and subsequent polymerization, polymers of cyclic diene compounds (cyclopentadiene, dicyclopentadiene, ethylidenenorbornene, dipentene, etc.) and hydrogenated products thereof, alicyclic hydrocarbon-based resins obtained by hydrogenation of aromatic rings of the following aromatic hydrocarbon resins and aliphatic/aromatic petroleum resins, etc.], aromatic hydrocarbon resins [polymers of vinyl group-containing aromatic hydrocarbons (styrene, vinyltoluene, α-methylstyrene, indene, methylindene, etc.) having 8 to 10 carbon atoms, etc.], aliphatic/aromatic petroleum resins (styrene-olefin-based copolymers, etc.) and various hydrocarbon-based resins such as aliphatic/alicyclic petroleum resins, hydrogenated hydrocarbon resins, coumarone-based resins and coumarone-indene-based resins.

Examples of the ketone-based tackifying resins include condensates of ketones such as methyl ethyl ketone, methyl isobutyl ketone, acetophenone, cyclohexanone and methylcyclohexanone with formaldehyde.

In order to prevent a decrease in cohesive force of the acrylic polymer A at a temperature of room temperature (27° C.) or higher and a decrease in holding performance and high-temperature adhesive performance of the acrylic viscoelastic composition, the (meth)acrylic oligomer preferably has a glass transition temperature (Tg) of 20° C. or higher (e.g., 20 to 200° C.) [preferably 30° C. or higher (e.g., 30 to 150° C.)]. Incidentally, the glass transition temperature (Tg) of the (meth)acrylic oligomer can be determined by DSC (differential scanning calorimetry).

As the acrylic monomer constituting the (meth)acrylic oligomer having a glass transition temperature (Tg) of 20° C. or higher, a (meth)acrylic acid ester having an alkyl group, a (meth)acrylic acid ester having an alicyclic hydrocarbon group, a (meth)acrylic acid ester having an aromatic hydrocarbon group and the like are preferable.

Specific examples of the acrylic monomer having an alkyl group include (meth)acrylic acid alkyl esters such as methyl (meth)acrylate, ethyl (meth)acrylate, propyl (meth)acrylate, butyl (meth)acrylate, pentyl (meth)acrylate, hexyl (meth)acrylate, 2-ethylhexyl (meth)acrylate, octyl (meth)acrylate, nonyl (meth)acrylate, decyl (meth)acrylate and dodecyl (meth)acrylate. Examples of the acrylic monomer having an alicyclic hydrocarbon group include cyclohexyl (meth)acrylate and isobornyl (meth)acrylate. Examples of the acrylic monomer having an aromatic hydrocarbon group include phenyl (meth)acrylate and benzyl (meth)acrylate.

These acrylic monomers can be used alone and in combination of two or more thereof. Therefore, the (meth)acrylic oligomer may be, for example, an oligomer obtained by copolymerizing several kinds of the monomers.

In the (meth)acrylic oligomer, a monomer having a polymerizable unsaturated bond capable of copolymerization (sometimes referred to as “copolymerizable unsaturated monomer”) may be used for the purpose of modification. The copolymerizable unsaturated monomers may be used alone or in combination of two or more thereof.

Examples of such a copolymerizable unsaturated monomer include alkoxyalkyl (meth)acrylates [e.g., (meth)acrylic acid, methoxyethyl (meth)acrylates, ethoxyethyl (meth)acrylates, propoxyethyl (meth)acrylates, butoxyethyl (meth)acrylates, ethoxypropyl (meth)acrylates, etc.], salts [e.g., (meth)acrylic acid alkali salts etc.], di(meth)acrylic acid esters of (poly)alkylene glycol [e.g., di(meth)acrylic acid esters of ethylene glycol, di(meth)acrylic acid esters of diethylene glycol, di(meth)acrylic acid esters of triethylene glycol, di(meth)acrylic acid esters of polyethylene glycol, di(meth)acrylic acid esters of propylene glycol, di(meth)acrylic acid esters of dipropylene glycol, di(meth)acrylic acid esters of tripropylene glycol, etc.], polyvalent (meth)acrylic acid esters [e.g., tri(meth)acrylic acid esters of trimethylolpropane etc.], (meth)acrylonitrile, vinyl acetate, vinylidene chloride, vinyl halide compounds [e.g., 2-chloroethyl (meth)acrylate etc.], (meth)acrylic acid esters of alicyclic alcohols [e.g., cyclohexyl (meth)acrylate etc.], oxazoline group-containing polymerizable compounds [e.g., 2-vinyl-2-oxazoline, 2-vinyl-5-methyl-2-oxazoline, 2-isopropenyl-2-oxazoline, etc.], aziridine group-containing polymerizable compounds [e.g., (meth)acryloylaziridine, 2-aziridinylethyl (meth)acrylate, etc.], epoxy group-containing vinyl monomers [e.g., allyl glycidyl ether, glycidyl ether (meth)acrylate, glycidyl ether (meth)acrylate, 2-ethylglycidyl ether (meth)acrylate, etc.], hydroxyl group-containing vinyl compounds [e.g., 2-hydroxyethyl (meth)acrylate, 2-hydroxypropyl (meth)acrylate, monoesters of (meth)acrylic acid with polypropylene glycol or polyethylene glycol, adducts of lactones with 2-hydroxyethyl (meth)acrylate, etc.], fluorine-containing vinyl monomers [e.g., fluorine-substituted methacrylic acid alkyl esters, fluorine-substituted acrylic acid alkyl esters, etc.], unsaturated carboxylic acids [e.g., itaconic acid, crotonic acid, maleic acid, fumaric acid, etc.] and salts thereof as well as (partially) esterified compounds and acid anhydrides thereof, reactive halogen-containing vinyl monomers [e.g., 2-chloroethyl vinyl ether, vinyl monochloroacetate, etc.], amide group-containing vinyl monomers [e.g., methacrylamide, N-methylolmethacrylamide, N-methoxyethylmethacrylamide, N-butoxymethylmethacrylamide, etc.], organic silicon group-containing vinyl compound monomers [e.g., vinyltrimethoxysilane, γ-methacryloxypropyltrimethoxysilane, allyltrimethoxysilane, trimethoxysilylpropylallylamine, 2-methoxyethoxytrimethoxysilane, etc.] and macromonomers having a radical-polymerizable vinyl group at an end of a monomer obtained by polymerization of vinyl groups.

The amount of the copolymerizable unsaturated monomer is, for example, 50% by weight or less, and preferably 30% by weight or less based on the total amount of the monomer components constituting the (meth)acrylic oligomer. When it is used more than 50% by weight, there is a possibility that pressure-sensitive adhesiveness is lowered.

The (meth)acrylic oligomer is obtained by a polymerization method commonly used as a synthetic method for (meth)acrylic oligomers, such as solution polymerization, emulsion polymerization, bulk polymerization, or suspension polymerization. In the emulsion polymerization and suspension polymerization, since there is a possibility that the emulsifier or dispersant used may adversely affect pressure-sensitive adhesiveness, the solution polymerization or bulk polymerization using no such agent is preferable. Moreover, the obtained (meth)acrylic oligomer may be any of a random copolymer, a block copolymer, a graft copolymer and an alternating copolymer.

The weight average molecular weight of the tackifying components B can be controlled to a desired molecular weight by using a known method (e.g., a method of using a chain transfer agent, a method of controlling the amount of the polymerization initiator, etc.).

For example, in the preparation of the (meth)acrylic oligomer, the weight average molecular weight of the (meth)acrylic oligomer can be suitably controlled by using a chain transfer agent in the polymerization. Examples of such a chain transfer agent include alkyl mercaptans having 1 to 15 carbon atoms (lauryl mercaptan, etc.), benzyl mercaptan, glycidyl mercaptan, thioglycolic acid, 2-ethylhexyl thioglycolate, 3-mercaptopropionic acid, 2-mercaptoethanol, benzyl alcohol, α-methylbenzyl alcohol, 2,3-dimethylcapto-1-propanol and α-methylstyrene dimer. Moreover, oligomers such as rosinic acid, rosinic acid esters and terpene resins can be also used for molecular weight control instead of the chain transfer agent.

The amount of the chain transfer agent is not particularly limited so long as a desired weight average molecular weight can be obtained but, for example, the amount thereof can be selected from the range of about 0.005 to 20 parts by weight (preferably 0.05 to 10 parts by weight) based on 100 parts by weight of the total monomer components constituting the (meth)acrylic oligomer. The chain transfer agent can be used alone or in combination of two or more thereof.

### Preparation Method of Acrylic Viscoelastic Composition

The acrylic viscoelastic composition is prepared using any method of, for example, (i) adding a tackifying component B to an acrylic polymer A obtained by polymerizing the acrylic monomer mixture by using the following polymerization method or the like, (ii) adding a tackifying component B to an acrylic monomer mixture constituting the acrylic polymer A to obtain an acrylic monomer mixture containing the tackifying component B (sometimes referred to as “tackifying component-containing acrylic monomer mixture”) and subsequently polymerizing the tackifying component-containing acrylic monomer mixture by the following polymerization method or the like.

The amount of the tackifying component B is an amount so as to contain the tackifying component B in an amount of 1 to 50 parts by weight (preferably 3 to 45 parts by weight, and more preferably 5 to 40 parts by weight) based on 100 parts by weight of the acrylic polymer A in the acrylic viscoelastic composition prepared. When the tackifying component B is added in an amount of more than 50 parts by weight, there is a case where elastic modulus of the acrylic viscoelastic composition becomes high and deterioration of adhesiveness at low temperature occurs and there is a case where pressure-sensitive adhesiveness is not exhibited at room temperature. Moreover, when the amount of the tackifying component B is less than 1 part by weight, the effect of improving the pressure-sensitive adhesiveness in the acrylic viscoelastic composition is not obtained in some cases.

The polymerization method to be used in the preparation of the acrylic viscoelastic composition is not particularly limited and any of commonly used polymerization processes such as solution polymerization, emulsion polymerization, bulk polymerization (photopolymerization using an active energy beam or thermal polymerization, etc.) and suspension polymerization. Of these, in view of productivity and environment, photopolymerization or thermal polymerization is preferably used. Particularly, photopolymerization is preferably used.

In this connection, the acrylic monomer mixture or the tackifying component-containing acrylic monomer mixture to be used in the preparation of the acrylic viscoelastic composition may be controlled in viscosity from the viewpoints of workability and the like. The control of the viscosity is advantageous, for example, in view of easy mixing of cells into the acrylic viscoelastic composition and easy application of the tackifying component-containing acrylic monomer mixture as a precursor in the case where a layer of the acrylic viscoelastic composition is formed on a predetermined surface (e.g., on a support).

It is preferable that the viscosity is 5 to 50 Pa·s (preferably 10 to 40 Pa·s) as viscosity measured by using a BH type viscometer under conditions of a rotor of a No. 5 rotor, a number of revolutions of 10 rpm, and a measuring temperature of 30° C. When the viscosity is less than 5 Pa·s, the viscosity is exceedingly low and flowability is high, so that it becomes difficult to apply the composition on the predetermined surface in some cases. When the viscosity exceeds 50 Pa·s, the viscosity is exceedingly high and it becomes difficult to apply the composition on the predetermined surface in some cases.

The viscosity of the acrylic monomer mixture or the tackifying component-containing acrylic monomer mixture may be controlled, for example, by a method of incorporating various polymer components such as an acrylic rubber and a thickening additive; a method of partially polymerizing the monomer components constituting the acrylic polymer A [e.g., the above-mentioned alkyl (meth)acrylates (a) etc.]; or the like method. Specifically, for example, there may be mentioned a method of subjecting the acrylic monomer mixture or the tackifying component-containing acrylic monomer mixture, containing a polymerization initiator (e.g., a photopolymerization initiator) to a polymerization reaction corresponding to the type of the polymerization initiator to prepare a composition (syrup) in which only part of the monomer components have been polymerized.

The acrylic viscoelastic composition can exhibit an excellent adhesive performance to a poorly-adherent adherend (particularly a polyolefin adherend, a poorly-adherent coated plate, etc.) and can be used as a pressure-sensitive adhesive capable of preventing a decrease in adhesive performance by long-term storage or high-temperature storage.

### Pressure-Sensitive Adhesive Tape or Sheet

The pressure-sensitive adhesive tape or sheet according to the present invention (“tape or sheet” is merely referred to as “tape” or “sheet” in some cases) has at least a pressure-sensitive adhesive layer including the above-mentioned acrylic viscoelastic composition. Such a pressure-sensitive adhesive tape may be a substrate-less pressure-sensitive adhesive tape having a constitution where the pressure-sensitive adhesive layer is formed alone or a substrate-attached pressure-sensitive adhesive tape having a constitution where a pressure-sensitive adhesive layer including the acrylic viscoelastic composition is formed at least one surface of the substrate. Moreover, since the pressure-sensitive adhesive layer including the acrylic viscoelastic composition may contain cells, the pressure-sensitive adhesive tape may be a substrate-less pressure-sensitive adhesive tape having a pressure-sensitive adhesive layer containing cells (referred to as “cell-containing substrate-less pressure-sensitive adhesive tape” in some cases) or a substrate-attached pressure-sensitive adhesive tape having a pressure-sensitive adhesive layer containing cells (referred to as a “cell-containing substrate-attached pressure-sensitive adhesive tape” in some cases).

Examples of the substrate-less pressure-sensitive adhesive tape include a substrate-less pressure-sensitive adhesive tape having a structure where the pressure-sensitive adhesive layer is constituted by only a pressure-sensitive adhesive layer including the above-mentioned acrylic viscoelastic composition and a substrate-less pressure-sensitive adhesive tape having a structure where the pressure-sensitive adhesive layer is constituted by a pressure-sensitive adhesive layer including the above-mentioned acrylic viscoelastic composition and a pressure-sensitive adhesive layer including the other pressure-sensitive adhesive [e.g., a known pressure-sensitive adhesive (e.g., an acrylic pressure-sensitive adhesive, a rubber-based pressure-sensitive adhesive, a vinyl alkyl ether-based pressure-sensitive adhesive, a silicone-based pressure-sensitive adhesive, a polyester-based pressure-sensitive adhesive, a polyamide-based pressure-sensitive adhesive, an urethane-based pressure-sensitive adhesive, a fluorine-based pressure-sensitive adhesive, an epoxy-based pressure-sensitive adhesive, etc.)]. Moreover, examples of the substrate-attached pressure-sensitive adhesive tape include a substrate-attached pressure-sensitive adhesive tape having a pressure-sensitive adhesive layer including the acrylic viscoelastic composition on one surface of a substrate, a substrate-attached pressure-sensitive adhesive tape having pressure-sensitive adhesive layers including the acrylic viscoelastic composition on the both surfaces of a substrate, a substrate-attached pressure-sensitive adhesive tape having a pressure-sensitive adhesive layer including the acrylic viscoelastic composition on one surface of a substrate and having a pressure-sensitive adhesive layer including the above-mentioned other pressure-sensitive adhesive on another surface of the substrate. The thickness of the other pressure-sensitive adhesive is not particularly limited and can be suitably selected depending on the purposes and methods of use.

Incidentally, the pressure-sensitive adhesive tape may be a single separator type having a constitution where the pressure-sensitive adhesive surface is protected with only one sheet of a release film (release liner) having release faces (release-treated faces) on both sides thereof or may be a double separator type having a constitution where the pressure-sensitive adhesive surface is protected with two release films having a release face at least one side.

Such a release film is not particularly limited and, for example, a commonly-used release paper or the like can be used. Specifically, as the release film, in addition to a substrate having a release-treated layer (peel-treated layer) which is treated with a release agent (peeling agent) at least one surface, there can be used a low adhesive substrate made of a fluorinated polymer (e.g., polytetrafluoroethylene, polychlorotrifluoroethylene, polyvinyl fluoride, polyvinylidene fluoride, tetrafluoroethylene-hexafluoropropylene copolymer or chlorofluoroethylene-vinylidene fluoride copolymer) or a low adhesive substrate made of a non-polar polymer (e.g., an olefin-based resin such as polyethylene or polypropylene). In a low adhesive substrate, both faces can be used as release faces. On the other hand, in a substrate having a release-treated layer, the release-treated layer surface is usable as the release face (release-treated face).

As the release film, it is preferable to use, for example, a release film having a release-treated layer at least one surface of a release film substrate (a substrate having a release-treated layer). Examples of such a release film substrate include plastic-based substrate films (synthetic resin films) such as polyester films (a polyethylene terephthalate film etc.), olefin-based resin films (a polyethylene film, a polypropylene film, etc.), a polyvinyl chloride film, polyimide films, polyamide films (a nylon film) and rayon films; papers (woodfree paper, Japanese paper, craft paper, glassine paper, synthetic paper, topcoat paper, etc.); and multilayered materials (two- or three-layered complexes) produced by laminating or co-extruding these materials.

The release agent is not particularly limited and, for example, a silicone-based release agent, a fluorinated release agent, a long-chain alkyl-based release agent and the like may be used. The release agents can be used alone or in combination of two or more thereof. A release film having been release-treated with the release agent can be formed by, for example, a known formation method.

The thickness of the release film is not particularly limited. From the viewpoints of easiness in handling and economic efficiency, the thickness may be selected from the range of, for example, 12 to 250 (preferably 20 to 200 μm). The film may have either a monolayer structure or a multilayer structure.

Furthermore, the pressure-sensitive adhesive tape may have other layer(s) (e.g., an intermediate layer, an undercoat layer, etc.) within the range where the effects of the invention are not impaired.

In the case where the pressure-sensitive adhesive tape of the invention is a substrate-attached pressure-sensitive adhesive tape, the substrate is not particularly limited and there can be used a suitable thin leafy body, for example, a paper substrate such as paper; a fibrous substrate such as cloth, nonwoven fabric and net (a material thereof can be suitably selected from hemp of Manila, rayon, polyester, pulp fiber and the like, for example); a metallic substrate such as metal foil (aluminum foil etc.) and a metal sheet; a plastic substrate such as a plastic film or sheet; a rubber-based substrate such as a rubber sheet; a foam such as a foam sheet; and a laminate thereof (e.g., a laminate of a plastic substrate with another substrate, or a laminate of plastic films (or sheets) with each other). As the substrate, a plastic substrate such as a plastic film or sheet can be suitably used. Examples of the material for such a plastic film or sheet include an olefin-based resin containing an α-olefin as a monomer component, such as polyethylene (PE), polypropylene (PP), ethylene-propylene copolymer and ethylene-vinyl acetate copolymer (EVA); a polyester-based resin such as polyethylene terephthalate (PET), polyethylene naphthalate (PEN) and polybutylene terephthalate (PBT); polyvinyl chloride (PVC); polyvinyl acetate-based resin; polyphenylene sulfide (PPS); an amide-based resin such as polyamide (nylon) and wholly aromatic polyamide (aramid); a polyimide-based resin; and polyether ether ketone (PEEK). These materials can be used alone or in combination of two or more thereof.

Incidentally, when a plastic substrate is used as the substrate, the deformability such as elongation percentage may be controlled by a stretching treatment or the like. Moreover, as the substrate, in the case where the pressure-sensitive adhesive layer is formed by curing with an active energy beam (photopolymerization), it is preferable to use a substrate which does not inhibit transmittance of the active energy beam.

In order to increase the adhesiveness with the pressure-sensitive adhesive layer including the above-mentioned acrylic viscoelastic composition, the surface of the substrate may be subjected to a commonly employed surface treatment, for example, an oxidation treatment by a chemical or physical method, such as treatment with corona, treatment with chromic acid, exposure to ozone, exposure to flame, exposure to high-voltage electric shock and treatment with ionizing radiation, or may be subjected to a coating treatment with a coating agent such as an undercoat agent, a release agent or the like.

The thickness of the substrate may be appropriately selected depending on the strength, flexibility, intended use, or the like. For example, the thickness is generally 1,000 μm or less (for example, from 1 to 1,000 μm), preferably from 1 to 500 μl, and more preferably about 3 to 300 μm but is not limited thereto. The substrate may have either a monolayer structure or a multilayer structure.

The pressure-sensitive adhesive tape can be prepared by providing a pressure-sensitive adhesive layer including the above-mentioned acrylic viscoelastic composition on the substrate or on the release face of the release film. Examples of the method for providing the pressure-sensitive adhesive layer including the above-mentioned acrylic viscoelastic composition on the substrate or on the release face of the release film include a method of applying the acrylic viscoelastic composition to form an acrylic viscoelastic composition layer as a pressure-sensitive adhesive layer, a method of applying the tackifying component-containing acrylic monomer mixture to provide a tackifying component-containing acrylic monomer mixture layer and polymerizing and curing (particularly photopolymerizing) the tackifying component-containing acrylic monomer mixture layer to form an acrylic viscoelastic composition layer as a pressure-sensitive adhesive layer.

More specifically, the substrate-less pressure-sensitive adhesive tape constituted by only the pressure-sensitive adhesive layer including the acrylic viscoelastic composition can be prepared, for example, by applying the acrylic viscoelastic composition on the release face of the release film to provide an acrylic viscoelastic composition layer as a pressure-sensitive adhesive layer or by providing a tackifying component-containing acrylic monomer mixture layer on the release face of the release film and polymerizing and curing the tackifying component-containing acrylic monomer mixture layer to provide an acrylic viscoelastic composition layer as a pressure-sensitive adhesive layer.

Moreover, the substrate-attached pressure-sensitive adhesive tape having a constitution containing a pressure-sensitive adhesive layer including the acrylic viscoelastic composition on one face of the substrate can be prepared by applying the acrylic viscoelastic composition on one face of the substrate to provide an acrylic viscoelastic composition layer as a pressure-sensitive adhesive layer or by providing a tackifying component-containing acrylic monomer mixture layer on the release face of the release film and polymerizing and curing the tackifying component-containing acrylic monomer mixture layer to provide an acrylic viscoelastic composition layer as a pressure-sensitive adhesive layer. Further, the tape can be also prepared by transferring the acrylic viscoelastic composition layer provided on the release face of the release film to one face of the substrate.

At the coating of the acrylic viscoelastic composition, the tackifying component-containing acrylic monomer mixture, or the like, a commonly employed coater (e.g., a roll coater, a bar coater, a die coater, or the like) may be used.

In the case where the acrylic viscoelastic composition layer as the pressure-sensitive adhesive layer is formed by photopolymerization (photo-curing) of the tackifying component-containing acrylic monomer mixture layer, it is preferable to perform the photopolymerization of the tackifying component-containing acrylic monomer mixture layer by irradiation with an active energy beam (e.g., ultraviolet ray) after the surface of the tackifying component-containing acrylic monomer mixture layer is temporarily covered with the release film or the like to prevent the layer from coming into contact with oxygen or under a nitrogen atmosphere. This is because the photopolymerization is inhibited by oxygen in the air and oxygen dissolved in the tackifying component-containing acrylic monomer mixture.

Examples of the light source to be used in the irradiation of ultraviolet ray include chemical lamp, black lamp, low-pressure mercury lamp, high-pressure mercury lamp, ultrahigh-pressure mercury lamp, metal halide lamp and fluorescent lamp. The light intensity thereof is not particularly limited but is about 0.1 to 300 mW/cm².

The pressure-sensitive adhesive layer including the acrylic viscoelastic composition in the pressure-sensitive adhesive tape may have either a monolayer structure or a multilayer structure. The thickness thereof is not particularly limited and, for example, can be selected from the range of 2 to 5,000 μm (preferably 5 to 2,000 μm).

The pressure-sensitive adhesive tape having the pressure-sensitive adhesive layer including the acrylic viscoelastic composition can exhibit an excellent adhesive performance to a poorly-adherent adherend, particularly a polyolefin adherend and a poorly-adherent coated plate in the pressure-sensitive adhesive surface provided by the pressure-sensitive adhesive layer including the acrylic viscoelastic composition and can prevent a decrease in adhesive performance by long-term storage or high-temperature storage.

### Adherends

A poorly-adherent adherend to which the pressure-sensitive adhesive tape having the pressure-sensitive adhesive layer including the acrylic viscoelastic composition is applied is not particularly limited and examples thereof include coating films (e.g., acid-rain resistant coating films, automotive coating films, etc.), coated plates, resinous plates (particularly polyolefin-based resinous plates, polystyrene-based resinous plates, etc.) and metallic plates such as steel plates. Moreover, a shape of the poorly-adherent adherend is also not particularly limited. Typically, the poorly-adherent adherend may be an adherend having a flat shape or a three-dimensionally curved shape; or may be a molded article having a flat shape or a three-dimensionally curved shape to which a coating treatment is applied.

Such a pressure-sensitive adhesive tape can be used, for example, in a method of attaching it to an automotive coating film to protect the coating film or a method of imparting ornaments. Moreover, the tape can be used in a method of bonding an article to the above automotive coating film. Examples of the article include exterior parts of automobiles, protective parts and ornamental parts of bodies and more specifically, malls, plates and the like may be mentioned.

The coating film as the adherend is not particularly limited and Examples thereof include various coating films such as polyester/melamine-based coating films, alkyd/melamine-based coating films, acrylic/melamine-based coating films, acrylic/urethane-based coating films, acrylic/polyacid curing agent-based coating films, epoxy group-containing acrylic/polyacid-based coating films and urethane-based coating films.

Furthermore, such a pressure-sensitive adhesive tape exhibits an excellent adhesiveness also to a coating film on which a surface control agent is bled. Such a surface control agent is not particularly limited and examples thereof include acrylic, vinyl, silicone-based, fluorine-based and other surface control agents.

### EXAMPLES

The following will describe the invention in more detail with reference to Examples but the invention is not limited by these Examples.

### Preparation Example 1 of Cyclohexyl Methacrylate Oligomer

After 95 parts by weight of cyclohexyl methacrylate and 3.5 parts by weight of thioglycolic acid were charged into a reaction vessel and mixed, nitrogen gas was introduced therein to remove dissolved oxygen, thereby a monomer solution being obtained. Then, the monomer solution was heated to 90° C. and a polymerization initiator-containing solution [a solution obtained by dissolving 0.005 part by weight of a polymerization initiator (trade name “PERHEXYL 0” manufactured by NOF Corporation) and 0.01 part by weight of a polymerization initiator (trade name “PERHEXYL D” manufactured by NOF Corporation) into 5 parts by weight of cyclohexyl methacrylate] was charged therein, followed by stirring at 90° C. for 1 hour. After stirring, the mixture was heated to 130° C. over a period of 1 hour and was stirred at 130° C. for 1 hour. Thereafter, the mixture was further heated to 170° C. over a period of 30 minutes, followed by stirring at 170° C. for 1 hour. Then, the temperature of 170° C. was maintained and pressure was reduced under stirring for 1 hour, whereby, the remaining monomer was removed and a cyclohexyl methacrylate oligomer (referred to as “CHMA oligomer (A)” in some cases) was obtained.

The weight average molecular weight of the CHMA oligomer (A) was 4,000 and the glass transition temperature (Tg) thereof was 55° C.

### Preparation Example 2 of Cyclohexyl Methacrylate Oligomer

Cyclohexyl methacrylate oligomer (referred to as “CHMA oligomer (B)” in some cases) was obtained in the same manner as in Preparation Example 1 of Cyclohexyl Methacrylate Oligomer except that 5.5 parts by weight of thioglycolic acid was used.

The weight average molecular weight of the CHMA oligomer (B) was 2,500.

### Preparation Example 3 of Cyclohexyl Methacrylate Oligomer

Cyclohexyl methacrylate oligomer (referred to as “CHMA oligomer (C)” in some cases) was obtained in the same manner as in Preparation Example 1 of Cyclohexyl Methacrylate Oligomer except that 1.7 parts by weight of thioglycolic acid was used.

The weight average molecular weight of the CHMA oligomer (C) was 7,000.

### Preparation Example 4 of Cyclohexyl Methacrylate Oligomer

Cyclohexyl methacrylate oligomer (referred to as “CHMA oligomer (D)” in some cases) was obtained in the same manner as in Preparation Example 1 of Cyclohexyl Methacrylate Oligomer except that 0.8 part by weight of thioglycolic acid was used.

The weight average molecular weight of the CHMA oligomer (D) was 13,000.

### Preparation Example 5 of Cyclohexyl Methacrylate Oligomer

Cyclohexyl methacrylate oligomer (referred to as “CHMA oligomer (E)” in some cases) was obtained in the same manner as in Preparation Example 1 of Cyclohexyl Methacrylate Oligomer except that 0.3 part by weight of thioglycolic acid was used.

The weight average molecular weight of the CHMA oligomer (E) was 25,000.

### Preparation Example of Cyclohexyl Methacrylate-Diethylacrylamide Copolymerized Oligomer

The cyclohexyl methacrylate/diethylacrylamide copolymerized oligomer (referred to as “CHMA/DEAA oligomer (A)” in some cases) was obtained in the same manner as in Preparation Example 1 of Cyclohexyl Methacrylate Oligomer except that 85 parts by weight of cyclohexyl methacrylate, 10 parts by weight of diethylacrylamide, and 3.5 parts by weight of thioglycolic acid were charged into a reaction vessel and nitrogen gas was introduced therein to remove dissolved oxygen to thereby obtain a monomer solution.

The weight average molecular weight of the CHMA/DEAA oligomer was 4000 and the glass transition temperature (Tg) thereof was 60° C.

### Preparation Example of Isobornyl Acrylate Oligomer

After 100 parts by weight of isobornyl acrylate, 3.5 parts by weight of thioglycolic acid and 60 parts by weight of ethyl acetate were charged into a reaction vessel and mixed, nitrogen gas was introduced therein to remove dissolved oxygen, thereby a monomer solution being obtained. Then, the monomer solution was heated to 70° C. and a polymerization initiator-containing solution [a solution obtained by dissolving 0.3 part by weight of azobisisobutyronitrile (AIBN) into 5 parts by weight of ethyl acetate] was charged therein, followed by stirring at 70° C. for 3 hours. After stirring, the mixture was heated to 80° C. over a period of 20 minutes and was stirred at 80° C. for 40 minutes, then, the polymerization was terminated. The resulting solution was dried at 130° C. for 3 hours and further dried under reduced pressure at 150° C. for 2 hours, whereby, the solvent and the remaining monomer were removed and an isobornyl acrylate oligomer (referred to as “IBXA oligomer” in some cases) was obtained.

The weight average molecular weight of the IBXA oligomer was 4200 and the glass transition temperature (Tg) thereof was 95° C.

### Preparation Example of Acrylic Syrup

2-Ethylhexyl acrylate (2EHA), 3-(4-methyl-cyclohexan-1-yl)-butyl acrylate (MCBA) and acrylic acid (AA) were charged into a reaction vessel in the ratios shown in the following Table 1, respectively, and 0.1 part by weight of a photopolymerization initiator (trade name “Irgacure 651” manufactured by Ciba Specialty Chemicals) was further charged therein, followed by mixing. Then, nitrogen gas was introduced therein to remove dissolved oxygen and the mixture was irradiated with ultraviolet ray (UV) until viscosity (a BH type viscometer, No. 5 rotor, 10 rpm, measuring temperature: 30° C.) became 15 Pa·s, thereby obtaining partially polymerized acrylic syrups (A) to (G).

The structural formula of 3-(4-methyl-cyclohexan-1-yl)-butyl acrylate (MCBA) was shown below.

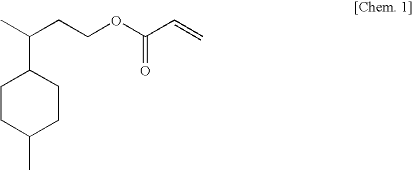

TABLE 1

| | Monomer composition [parts by weight] | | |
|---|---|---|---|
| | 2EHA | MCBA | AA |
| Acrylic syrup (A) | 85 | 10 | 5 |
| Acrylic syrup (B) | 75 | 20 | 5 |
| Acrylic syrup (C) | 35 | 60 | 5 |
| Acrylic syrup (D) | 55 | 40 | 5 |
| Acrylic syrup (E) | 95 | 0 | 5 |
| Acrylic syrup (F) | 93 | 2 | 5 |
| Acrylic syrup (G) | 15 | 80 | 5 |

### Examples 1 to 12 and Comparative Examples 1 to 9

As shown in the following Table 2, a tackifying component corresponding to each of Examples and Comparative Examples was added in a respective amount to 100 parts by weight of an acrylic syrup corresponding to each of Examples and Comparative Examples. Further, 0.1 part by weight of hexanediol diacrylate was added thereto to obtain an acrylic viscoelastic composition precursor.

The acrylic viscoelastic composition precursor was applied, by roll coater, on the release-treated face of a polyester film (silicone-treated product, trade name “LUMIRROR S-10 #38” manufactured by Toray Industries Inc.) having a thickness of 38 μm whose one surface had been release-treated, so as to be a thickness after curing of 50 μm, thereby forming an acrylic viscoelastic composition precursor layer. Then, the above-mentioned polyester film having a thickness of 38 μm whose one surface had been release-treated was attached onto the acrylic viscoelastic composition precursor layer in such a manner that the release-treated face and the acrylic viscoelastic composition precursor layer come into contact with each other.

Then, ultraviolet ray irradiation (luminance: 5 mW/cm², 3 minutes) was performed from both sides by using black light to cure the acrylic viscoelastic composition precursor layer, whereby an acrylic viscoelastic composition layer was formed. Thus, a pressure-sensitive adhesive tape having a pressure-sensitive adhesive layer including the acrylic viscoelastic composition layer was obtained.

TABLE 2

| | | Tackifying component | |
|---|---|---|---|
| | | | Mixing |
| | | | amount |
| | A- | | [parts |
| | crylic | | by |
| | Syrup | Kind | weight] |
| Example 1 | A | CHMA oligomer (A) | 20 |
| Example 2 | B | CHMA oligomer (A) | 20 |
| Example 3 | C | CHMA oligomer (A) | 20 |
| Example 4 | D | CHMA oligomer (A) | 5 |
| Example 5 | D | CHMA oligomer (A) | 20 |
| Example 6 | D | CHMA oligomer (A) | 40 |
| Example 7 | D | KR-1840 | 10 |
| Example 8 | D | CHMA oligomer (B) | 20 |
| Example 9 | D | CHMA oligomer (C) | 20 |
| Example 10 | D | CHMA oligomer (D) | 20 |
| Example 11 | D | CHMA/DEAA oligomer (A) | 20 |
| Example 12 | D | IBXA oligomer | 20 |
| Comparative Example 1 | A | — | — |
| Comparative Example 2 | D | — | — |
| Comparative Example 3 | C | — | — |
| Comparative Example 4 | E | — | — |
| Comparative Example 5 | E | CHMA oligomer (A) | 20 |
| Comparative Example 6 | F | — | — |
| Comparative Example 7 | F | CHMA oligomer (A) | 20 |
| Comparative Example 8 | G | CHMA oligomer (A) | 20 |
| Comparative Example 9 | D | CHMA oligomer (E) | 20 |

In table 2, “KR-1840” means a hydrogenated rosin-based resin (trade name “KR-1840” manufactured by Arakawa Chemical Industries, Ltd.) and “-” means that no tackifying component was used.

### Example 13

A substrate-attached pressure-sensitive adhesive tape having a pressure-sensitive adhesive layer including an acrylic viscoelastic composition layer was obtained by attaching the acrylic viscoelastic composition layer obtained in Example 5 onto one surface of an acrylic foam substrate (composition: 90 parts by weight of 2-ethylhexyl acrylate, 10 parts by weight of acrylic acid and 20% by volume of glass balloon, cells: 20% by volume) having a thickness of 1.52 mm.

### Comparative Example 10

A substrate-attached pressure-sensitive adhesive tape having a pressure-sensitive adhesive layer including an acrylic viscoelastic composition layer was obtained by attaching the acrylic viscoelastic composition layer obtained in Comparative Example 2 onto one surface of an acrylic foam substrate (composition: 90 parts by weight of 2-ethylhexyl acrylate, 10 parts by weight of acrylic acid and 20% by volume of glass balloon, cells: 20% by volume) having a thickness of 1.52 mm.

### Measurement of Molecular Weight

The molecular weight of oligomers was measured by GPC (gel permeation chromatography).

Apparatus: (product name) HLC-8120 GPC (manufactured by Tosoh Corporation)

Columns: (column item Nos.) TSKgel SuperHZM-H/HZ4000/HZ3000/HZ2000

Column size: 6.0 mm I.D.×150 mm

Eluent: THF (tetrahydrofuran)

Flow rate: 0.6 ml/min

Detector: differential refractometer (RI)

Column temperature: 40° C.

Injection amount: 20 ml

The molecular weight was calculated in terms of polystyrene standard.

### Measurement of Glass Transition Temperature

The glass transition temperature (Tg) of oligomers was measured by DSC (differential scanning calorimetry).

Analytical apparatus: (product name) DSC6220 (manufactured by SII Nano Technology Inc.)

Measuring temperature range: −150° C. to 210° C.

Elevating temperature: 10° C./min

Atmospheric gas: N₂ (flow rate: 30 ml/min)

### Evaluation

With regard to Examples and Comparative Examples, evaluation was carried out by measuring adhesive strength and conversion. The results are shown in Table 3.

### Method for Evaluating Adhesive Strength

The adhesive strength of the pressure-sensitive adhesive tapes normally stored (stored at room temperature (27° C.) for 3 days after preparation) and stored under heating [stored at room temperature for 3 days after preparation and then further stored at 90° C. for 4 days (corresponding to storage at room temperature for about half year)] to a polypropylene plate (PP plate) and a coated plate was determined by the following method for measuring adhesive strength.

In this connection, the coated plate is a plate obtained by process-coating of a steel plate having a thickness of 0.8 mm with an electrodeposited primer and an intermediate coat and forming an epoxy group-containing acryl/polyacid-based coating film as a final coat.

Moreover, the surface of the polypropylene plate and the surface of the coated plate as adherends were washed by wiping them with waste cloth wetted with isopropyl alcohol before measurement.

### Method for Measuring Adhesive Strength

A pressure-sensitive adhesive tape was cut into a size having a width of 25 mm and a length of 100 mm to form a sample for measurement. Then, the polyester film at one side of the sample for measurement was peeled off and the sample was attached to a substrate made of polyethylene terephthalate (thickness: 25 μm, trade name “LUMIRROR S-10 #25” manufactured by Toray Industries Inc.). Thereafter, the polyester film at another side was peeled off and the sample was attached to an adherend by one-way pressure adhesion with a 5 kg roller, followed by standing at 23° C. for 30 minutes. After standing, the sample was peeled from the adherend under an atmosphere of 23° C. and 65% RH under conditions of a peeling angle of 180° and a drawing rate of 300 mm/min using a tensile tester (trade name “TG-1KN” manufactured by Minebea Co., Ltd.). A maximum load at the time of peeling (a maximum value of load excluding a peak top at the initial stage of the measurement) was measured and the maximum load was regarded as adhesive strength (N/25 mm) of the acrylic viscoelastic composition layer.

### Method for Measuring Conversion

The acrylic viscoelastic composition layer was cut into a predetermined size (about 0.5 g) to form a sample for measurement. Then, the weight of the sample for measurement was precisely measured and was regarded as an initial weight. Next, the sample for measurement was left standing at 130° C. for 2 hours for drying and the weight of the sample for measurement after drying was precisely measured and was regarded as weight after drying. Then, the conversion was determined from the following formula.

Conversion of Acrylic Viscoelastic Composition Layer=(Weight after Drying)/(Initial Weight)×100

TABLE 3

| | Adhesive strength [N/25 mm] | | | | |
|---|---|---|---|---|---|
| | To PP plate | | To coated plate | | |
| | Normal | Heat | Normal | Heat | Conversion |
| | storage | storage | storage | storage | [%] |
| Example 1 | 11.5 | 7.8 | 17.5 | 12.5 | 99.3 |
| Example 2 | 11.9 | 12.0 | 18.2 | 19.3 | 99.2 |
| Example 3 | 9.4 | 10.1 | 15.3 | 16.4 | 99.2 |
| Example 4 | 8.5 | 8.8 | 11.3 | 11.6 | 99.1 |
| Example 5 | 12.2 | 13.1 | 19.9 | 20.5 | 99.0 |
| Example 6 | 13.3 | 13.2 | 25.1 | 22.2 | 99.3 |
| Example 7 | 7.0 | 7.2 | 10.1 | 10.5 | 96.3 |
| Example 8 | 12.5 | 13.6 | 20.2 | 20.9 | 99.2 |
| Example 9 | 11.1 | 10.9 | 17.5 | 16.7 | 98.9 |
| Example 10 | 8.8 | 7.8 | 11.2 | 9.9 | 99.0 |
| Example 11 | 10.5 | 10.7 | 20.7 | 21.8 | 98.5 |
| Example 12 | 8.7 | 9.3 | 14.8 | 15.3 | 98.8 |
| Example 13 | — | — | 59.3 | 61.7 | — |
| Comparative | 6.6 | 6.6 | 7.5 | 7.7 | 99.1 |
| Example 1 | | | | | |
| Comparative | 7.2 | 7.5 | 8.2 | 8.3 | 99.1 |
| Example 2 | | | | | |
| Comparative | 7.5 | 7.3 | 9.0 | 9.1 | 99.3 |
| Example 3 | | | | | |
| Comparative | 5.7 | 5.9 | 6.0 | 6.2 | 99.2 |
| Example 4 | | | | | |
| Comparative | 9.3 | 6.3 | 13.5 | 8.4 | 98.8 |
| Example 5 | | | | | |
| Comparative | 5.5 | 5.7 | 6.3 | 6.3 | 99.1 |
| Example 6 | | | | | |
| Comparative | 9.2 | 6.0 | 13.7 | 8.2 | 98.7 |
| Example 7 | | | | | |
| Comparative | x | x | x | x | 98.5 |
| Example 8 | | | | | |
| Comparative | 4.3 | 3.8 | 4.5 | 4.0 | 99.3 |
| Example 9 | | | | | |
| Comparative | — | — | 58.4 | 28.7 | — |
| Example 10 | | | | | |

In Table 3, “-” means that measurement was not performed and “x” means that measurement was impossible. Incidentally, Comparative Example 8 was impossible to measure since the case showed no tackiness and was not attached to the adherend.

While the invention has been described in detail and with reference to specific embodiments thereof, it will be apparent to one skilled in the art that various changes and modifications can be made therein without departing from the spirit and scope thereof.

The present application is based on Japanese Patent Application No. 2007-175957 filed on Jul. 4, 2007, and the contents are incorporated herein by reference.

Also, all the references are incorporated as a total.

### INDUSTRIAL APPLICABILITY

According to the acrylic viscoelastic composition of the invention, owing to the above-mentioned constitution, it is possible to exhibit an excellent adhesive performance to a poorly-adherent adherend, particularly a polyolefin adherend or a poorly-adherent coated plate and can prevent a decrease in adhesive performance by long-term storage or high-temperature storage. Moreover, the pressure-sensitive adhesive tape or sheet of the invention can exhibit an excellent adhesive performance to a poorly-adherent adherend, particularly a polyolefin adherend or a poorly-adherent coated plate and can prevent a decrease in adhesive performance by long-term storage or high-temperature storage.

1. An acrylic viscoelastic composition comprising:
an acrylic polymer A obtained by polymerizing an acrylic monomer mixture containing an alkyl(meth)acrylate (a) and a terpene-based (meth)acrylate (b), the terpene-based (meth)acrylate (b) being contained in an amount of 5 to 70% by weight based on the total monomer components of the acrylic monomer mixture; and
a tackifying component B having a weight average molecular weight of 2,000 to 20,000.

2. The acrylic viscoelastic composition according to claim 1,
wherein the tackifying component B is contained in an amount of 1 to 50 parts by weight based on 100 parts by weight of the acrylic polymer A.

3. The acrylic viscoelastic composition according to claim 1, wherein the acrylic polymer A further contains, as a monomer component, a polar group-containing monomer (c) copolymerizable with the alkyl (meth)acrylate (a), in an amount of 0.1 to 20% by weight based on the total monomer components of the acrylic monomer mixture.

4. The acrylic viscoelastic composition according to claim 1, wherein the acrylic monomer mixture further contains a photopolymerization initiator in an amount of 0.001 to 5 parts by weight based on 100 parts by weight of the total monomer components of the acrylic monomer mixture.

5. The acrylic viscoelastic composition according to claim 1, wherein the tackifying component B is a (meth)acrylic oligomer.

6. The acrylic viscoelastic composition according to claim 5, wherein the (meth)acrylic oligomer has a glass transition temperature (Tg) of 20° C. or higher.

7. The acrylic viscoelastic composition according to claim 1, wherein the tackifying component B contains a chain transfer agent in an amount of 0.005 to 20 parts by weight based on 100 parts by weight of the total monomer components constituting the tackifying component B.

8. A pressure-sensitive adhesive tape or sheet having a pressure-sensitive adhesive layer comprising the acrylic viscoelastic composition according to claim 1.

9. A pressure-sensitive adhesive tape or sheet comprising a substrate; and a pressure-sensitive adhesive layer comprising the acrylic viscoelastic composition according to claim 1 provided on at least one surface of the substrate.
